(19) United States
(12) Patent Application Publication
(10) Pub. No.: US 2014/0156773 A1
(43) Pub. Date: Jun. 5, 2014

(54) MESSAGING SYSTEM FEATURING CONTROLLED DISTRIBUTION AND ACCESS TO SETS OF MESSAGES

(71) Applicant: Trenton Gary Coroy, Steinbach (CA)

(72) Inventors: Trenton Gary Coroy, Steinbach (CA); Timothy Roy Koop, Ste. Anne (CA)

(73) Assignee: Trenton Gary Coroy, Steinbach (CA)

(21) Appl. No.: 14/093,633

(22) Filed: Dec. 2, 2013

Related U.S. Application Data
(60) Provisional application No. 61/732,567, filed on Dec. 3, 2012.

(51) Int. Cl. H04L 12/58

(52) U.S. Cl. CPC H04L 51/32
USPC 709/206

(57) ABSTRACT

A communication system comprises a plurality of electronic devices and a server in data communication with the plurality of electronic devices having at least one processor. The processor is configured for generating a message that is accessible only by authorized receivers having associated user identifiers, generating a notice indicative of the message, communicating the notice to the first receiver having an associated first user identifier, and automatically granting the first receiver access to the message.

### RELATED APPLICATIONS

This application claims priority to U.S. Provisional Application No. 61/732,567, filed on Dec. 3, 2012 and entitled “MESSAGING SYSTEM FEATURING CONTROLLED DISTRIBUTION AND ACCESS TO SETS OF MESSAGES”.

### TECHNICAL FIELD

The embodiments herein relate to electronic communication systems, and in particular to electronic messaging systems for electronic social networks.

### INTRODUCTION

Electronic social networks generally refer to a virtual community of individuals who communicate to each other through various electronic devices over a communication network such as the Internet. The participants of the social networks may know each other in-person or in some cases, the participants may not know each other outside of the electronic social network.

The participants may communicate with other participants using various electronic communication means. For example, the participants may use electronic mail (i.e. “email”) and/or use tools provided through various online forums. Participants may also use one or more online social networking applications which provide various features that are designed to facilitate social networking.

These social networking applications may facilitate communication amongst millions of participants. For example, millions of users participate in social networks facilitated by applications provided by Facebook™, MySpace™, and/or Twitter™. These applications typically offer ways for participants to communicate with either targeted specific individuals, or to the community in general. For example, social networking applications may provide locations (e.g. a user profile, or a message thread) where a user may post a note, photo, video or some other information that the user would like to share with visitors to that location. Social networking applications also typically offer private messaging systems that may be used to communicate with selected members of the social network in private. The private messaging systems provided by various social networking applications are generally similar to email messaging systems.

A major concern with electronic social networks is privacy. Many social networking applications provide one or more privacy features to help ensure that only intended individuals receive and view certain materials. However, in some cases, the existing privacy features provided by the current systems may not be sufficient to obtain desired privacy for certain situations. Alternatively, these privacy features may require a large amount of user input, or be difficult to locate, or be difficult to understand making it onerous and/or challenging for the users to engage the privacy features.

### BRIEF DESCRIPTION OF THE DRAWINGS

Various embodiments will now be described, by way of example only, with reference to the following drawings, in which:

FIG. 1 is a schematic diagram of an electronic social network system according to some embodiments;

FIG. 2 is a schematic diagram illustrating a set of messages that may be generated using the system shown in FIG. 1;

FIG. 3 is an exemplary set table that may store various information about various sets of messages as the set shown in FIG. 2;

FIG. 4 is an exemplary messages table that may store various information about various messages as the messages shown in FIG. 2;

FIG. 5 is a schematic diagram illustrating by example how a user may engage with the system shown in FIG. 1;

FIG. 6 is an exemplary access table storing various access information relating to the example shown in FIG. 5; and

FIG. 7 is a schematic diagram illustrating an electronic messaging method according to some embodiments.

### DETAILED DESCRIPTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

In some cases, the embodiments of the systems and methods described herein may be implemented in hardware or software, or a combination of both. In some cases, embodiments may be implemented in one or more computer programs executing on one or more programmable computing devices comprising at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

The subject system and methods are described in the context of a faith-based social network. However, it should be understood that the various aspects of various embodiments described herein may be applicable to other types of social networks and/or communication systems.

One challenge faith based social networks may face is how requests/messages sent to a certain members of the social network are handled by the application facilitating the social network. For example, a person may wish to send prayer requests to and receive prayer requests from one or more other people. Some prayer groups may use emails as the primary means of communication. For example, a member and/or leader of a prayer group may use a group email list or some other form of email distribution system to communicate with the group. If a member of the prayer group has a prayer request, he or she may email the prayer request to the entire group. Alternately, he or she may communicate the prayer request to a group leader, who may then email the prayer request to the entire group.

In some cases, people may use online messaging forums to communicate various prayer requests. For example, in an online forum, a prayer request may be posted on a message thread. In some cases access to the message thread may be restricted to members of a prayer group. Members of the prayer group may review the message thread to obtain information about the prayer request. Members of the prayer group may also be able to participate by posting messages to the thread, although in some cases permission to post to the thread may be more limited. Members may also subscribe to the thread to obtain notification when the thread is updated or when a new message is posted to the thread.

While the approaches described above allow prayer requests to be communicated, they lack monitoring information, privacy and/or control features.

For example, when an email containing a prayer request is sent to a prayer group, copies of that email may be delivered to various prayer group members' email inboxes. However, the sender's email system does not track whether the prayer request has been viewed, accepted, or declined by the recipient. The sender's email system also lacks an effective means to determine and track whether or not various recipients wish to be notified of updates to this particular prayer request. Furthermore the sender's email system cannot determine whether the prayer request has actually been delivered to a recipient's inbox or if, for example, it may have been classified as “spam” and delivered to a folder dedicated to spam or discarded.

As another example, the sender's email system generally cannot prevent messages from being forwarded (i.e. re-sent) by a recipient to one or more other recipients. The sender's email system also does not track if recipients have forwarded the message, and if the message has been forwarded, to whom the message was forwarded.

The information contained in prayer requests and certain other types of messages may be confidential and/or personal in nature and the author (or original sender) may not wish for the information to be forwarded or distributed to individuals outside of an intended group of recipients.

In some cases, the author may only wish that the prayer request be forwardable by recipients who are no more than one, two, or any other designated number of communications removed from the author. For example, the author may wish to allow only those who receive the request directly from the author to be able to forward the request. In some cases, the author may prefer that the prayer request is delivered to as many people as possible, and may wish to have no limits on the forwardability of the request.

The author may also wish to limit the visibility of the prayer request to a certain time period. For example, if the prayer request sent to a number of recipients, each recipient may have access to view the prayer request for a given period of time. After that period of time has expired, only the individuals who have accepted the prayer request may continue to view the prayer request. The length of the time and/or expiry time may apply to all recipients or may be different for one recipient than for one or more others. The expiry time may be predetermined, or may be triggered by an event, for example by the closing or archiving of the prayer request.

In some cases, the author may not wish to share the same amount of information with all of the recipients. For example, the author may not wish to share their email address and/or other personal information with all of the recipients of the prayer request, especially where the prayer request is forwarded to a large number of recipients that the author may not know personally.

In some cases, the author may wish to know who has viewed or read the prayer request. Furthermore, the author may wish to know which of the people who read the prayer request have “accepted” the request and agreed to take some action (for example to pray) related to the given request.

In some cases, the author may also like to provide updates (e.g. additional information) for a prayer request. For example, if the prayer request is concerned with an illness of one of the author's relatives, the author may wish to provide updates on this person's progress to those who are praying. In email systems, it may be difficult for the author to send updates to all recipients of the prayer request if the emails have been forwarded, as the author may not know to whom the request has been forwarded. The author may also wish to limit the updates to only those individuals who have accepted the prayer request. The author may also wish to allow individuals who have accepted the prayer request to ask for an update on the request, without necessarily granting them direct personal contact information such as email, phone number, etc.

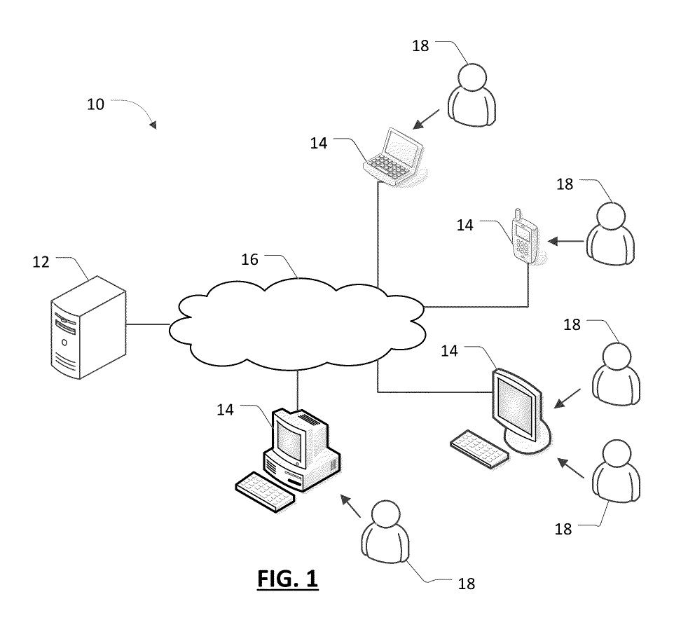

Referring now to FIG. 1, illustrated therein is an electronic social network 10 having a messaging system featuring controlled distribution, access control and access monitoring in some embodiments. The social network 10 includes a server 12 in data communication with a plurality of electronic devices 14 through a network 16, which may comprise the Internet. Various users 18 access the social network 10 using the electronic devices 14.

The electronic devices 14 may be laptops, desktops, tablet computers, game consoles, personal data assistants (PDA), smart phones, terminals or any other suitable electronic device that can access the network 16 to connect to the server 12.

In some cases, each electronic device may be used by a single user. In other cases, multiple users may share one of the electronic devices 14 to access the social network. In some embodiments, the users may be required to log on using a user identifier and a password.

The server 12 may be a web server that provides web pages to the electronic devices 14. The electronic devices 14 may interface with the server 12 using various web browsing applications or applications that are dedicated to accessing the server 12. In some cases, the server 12 may include a plurality of physical computers located in one or more geographical locations.

The server 12 may include one or more computer processors that are configured to provide a social networking application including an electronic messaging tool whose features are described herein below. The users may interact with the server 12 to form a social network where prayer requests and/or other messages are communicated.

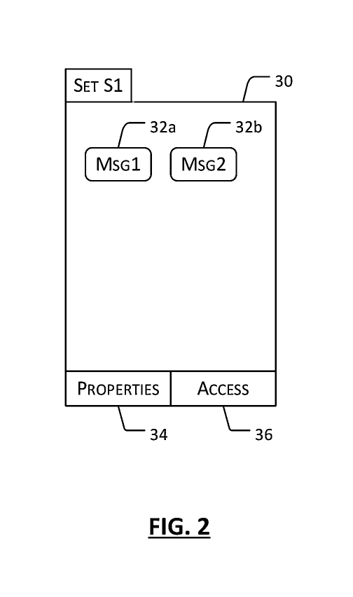

Referring now to FIG. 2, illustrated therein is an exemplary set of messages, indicated by reference numeral 30. The set 30 comprises a plurality of messages 32a and 32b. The set 30 and the messages 32a and 32b may be generated by a user of the system 10 to convey prayer requests to one or more other users and or one or more other individuals who may not be part of the social network. In general a set may comprise one or more messages, and the user that generates a set may be referred to as a set author. In some embodiments a set may have multiple set authors.

In the example as shown, the messages 32a and 32b are contained in (i.e. associated with) the set 30. The set 30 may be generated automatically when the first message 32a in the set is initially generated. However, in other cases, the messages may be managed without a set. That is, the messages may or may not be contained in or otherwise associated with one or more sets in other embodiments.

In some cases, a set 30 may have additional messages added to it. These types of sets may be referred to as “open sets” or being “open”. In some cases, a set 30 may not, or may no longer have additional messages added to it. These types of sets may be referred to as “closed sets” or being “closed”.

In some cases, once a message in a set is created, only an author of the message and/or an author of the set containing the message may modify that message. In some cases messages may only be modified for a predetermined period of time after being created. In some cases messages may not be modified once created, or may not be modified once shared with another user. In some cases, messages may be editable by any user, or by users granted permission by an set author and/or message author.

Making changes to a set, either by adding one or more new messages to the set or by modifying one or more existing messages in the set may be referred to as “updating” the set.

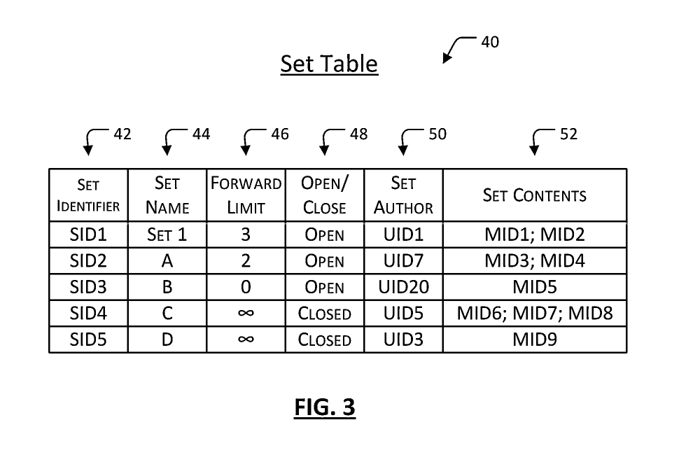

In some cases, there may be one or more set properties associated with each set. For example, the set 30 has set properties 34 associated therewith. The set properties may include one or more of set name, set type or set classification, open/closed status, distribution/forwardability rules and other information. Some exemplary set properties are described with reference to FIG. 3 herein below.

In some embodiments, there may be one or more set access settings associated with each set. For example, the set 30 has set access settings 36 associated therewith. The set access settings may include permission settings indicative of who may view, add messages to a set, or modify an existing set.

In some cases, there may be one or more message access settings associated with one or more message in the set. That is, the access settings for each of the messages in a set may be individually defined, rather than all the messages in the set having the same access settings. The access settings for each message may include permission settings indicative of who may view, or modify an existing set.

In some embodiments, access to each message may be granted on a message-by-message basis. In some embodiments, access may be granted at the set-level such that access to a set provides access to all the messages contained therein.

In some embodiments, each set and information related to the set may be stored as a row of a set table in a relational database, for example as shown in FIG. 3. The set table 40 may be stored in a data storage device.

Referring now to FIG. 3, illustrated therein is an exemplary table 40 for recording various sets and set properties. Each row of the table 40 includes information about a particular set and each column of the table 40 indicates the type of information.

The table 40 has a Set_Identifier column 42 for storing a set identification value associated with each set. The set identification value may be generated each time a new set is created. The set identification value may be globally unique and/or unique to the table 40.

The table 40 also includes a Set_Name column 44 that stores information about the name of the set. The name of the set may be given by an author of the set. In some cases, the name of the set may be the title of the set.

The table 40 also includes a Forward_Limit column 46. The value in the column 46 may indicate how many times the particular set may be forwarded. A limit of “0” would indicate that no forwards are permitted while a null value (i.e. no limit) may indicate that there is no forwarding limit. In some cases, a different value or symbol may be used to represent no limits (e.g. a value of “99” or an infinity symbol as shown in FIG. 3).

The table 40 also includes an Open_Close column 48. The open or close column may indicate whether or not additional messages may be added to a set. As shown, an open set is indicated by the value “OPEN” while a closed set is indicated by the value “CLOSED”. In other cases, an open set may be indicated by a Boolean value “TRUE” while a closed set may be indicated by the value “FALSE”. If the set is open, new messages may be posted to the set. If the set is closed, no additional messages may be posted to the set.

The table 40 also includes Set_Author column 50. The author column 50 includes information about the user that created the set. For example, the author column 50 may store a user identifier for an author of the set. In some cases, any selected user identifier may be stored as the author of the set even though the stored user identifier may not correspond to the user that generated the set. In some embodiments, more than one user identifier may be stored in column 50. For example, an author may wish to share his or her authorship with one or more other users. That is, more than one user may be designated as an author of the set in each row.

The table 40 also includes a Set_Content column 52. The column 52, for example may store various message identifiers associated with various messages “contained” in the set. In some embodiments, values other than the message identifiers may be stored.

The arrangement and configuration of the set table 40 described herein is only for illustrative purposes. In other embodiments, the table may be organized in a different manner, may contain different information and/or the rows and columns in the table may be configured in some other way. In some embodiments, various set properties may be stored using other suitable data structures that may or may not be in a table format.

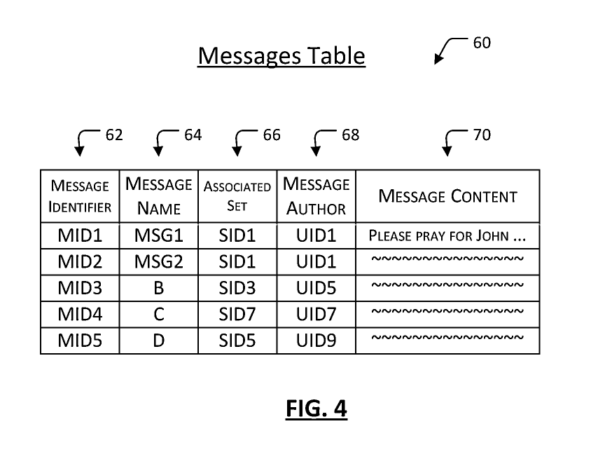

Referring now to FIG. 4, illustrated therein is a messages table 60 for recording various messages and message properties. Each row of the table 60 includes information about a particular message and each column of the table 60 indicates the type of information.

The messages table 60 includes a Message_Identifier column 62 for storing a message identification value associated with each message. The message identification value may be generated each time a new message is created. The message identification value may be globally unique and/or unique to the table 60.

The messages table 60 also includes a Message_Name column 64 for storing names of each message. The name of the message may be provided by an author of the message. In some cases, the name of the message may be the title of the message.

The messages table 60 also includes an Associated_Set column 66. The value stored in the column 66 indicates which set each message is associated with. For example, the set column 66 may store a set identifier value (e.g. a value from column 42 of table 40) associated with the message in that row. In some cases, more than one set may be associated with each message.

The messages table 60 also includes Message_Author column 68. The value stored in the column 68 is indicative of an author of the message. For example, a user identifier associated with a user who generated the message may be stored in the column 68. In some cases, any selected user identifier may be stored as an author of the message even though the stored user identifier may not correspond to the user that generated the message. In some embodiments, more than one user identifier may be stored in column 68. For example, an author may wish to share his or her authorship with one or more other users. That is, more than one user may be designated as an author of the message in each row.

The messages table 60 also includes Content column 70. The Content column 70 includes values indicative of the content of the message. In some cases, the values may comprise the body or the text of the message. In some cases, the content Column may comprise links (e.g. URLs), images, video content, audio content, or information in other various suitable formats that may be included in the message.

The arrangement and configuration of the messages table 60 described herein is only for illustrative purposes. In other embodiments, the table may be organized in a different manner, contain different information and/or the rows and columns in the table may be configured in some other way. In some embodiments, various message properties may be stored using other suitable data-structures that may or may not be in a table format.

The system 10 may provide a number of ways by which a message and/or a set may be communicated to one or more users of the system 10 or external recipients.

In some embodiments, the message or the set may be communicated to one or more recipients by generating at least one notice indicative of the message or the set, and communicating the notice to various recipients. The notice may include information about where the message or the set may be located and/or when the message or the set was generated. The notice may include a notice message. For example, when a user “sends” a message or set they have authored, or “forwards” a message or set someone else has authored by means of communicating a notice, they may wish to include with that notice a notice message such as a personal comment related to the message or set.

Notices may be communicated to various recipients using various means, and may be communicated in various formats. For example, a notice may be sent using email, text messaging, internal messaging, and so on. In some embodiments, the recipients of the notices may be granted at least temporary access to the set or message as described herein below.

In some embodiments, an author may publish a notice for a set or message at a location, which may be referred to as publishing the set or message at the location. Publishing the set at a location may grant at least temporary access to users who are able to access the set and/or view information from the set where it is published. For example, a set may be published at the author's social networking profile. In such cases, access to the set may be determined by access to the author's profile. That is, anyone who can access the author's social networking profile may access the set and conversely, anyone who is prevented from accessing the author's social networking profile may be prevented from accessing the set. In some cases, the social networking profile may have privacy settings configurable to restrict who has access to sets published in the profile. In such cases, these privacy settings may determine or may influence the determination of who can access the sets that are published to the profile.

In some cases, when a notice associated with a message or a set is published at a location, users who are able to access the notice location may also be provided with notices by different means. For example, a notice may also be communicated to these users via email, text messaging, internal messaging or other communication means. For example, a user who has subscribed to be notified of updates to a profile (i.e. is “following” a profile) may receive an additional notice to indicate that a notice has been published to that profile.

In some cases, only an author may publish the notice at a location. In other cases, users other than an author may be permitted to publish the notice at one or more locations. For example, a user who has accepted a message or a set may wish to publish a notice associated therewith in his or her own social networking profile.

In some cases, notices for the same message or set may be received from more than one source. For example, an author of a set may send that set to a particular user, and another user who is not an author of the set may forward that same set to the same particular user. The particular user will receive both a sending notice and a forwarding notice related to the same set. In practice it is expected that a user might in some cases receive many notices for the same message or set. In such cases, notice arbitration may be conducted to improve user experience by suppressing duplicate notices. For example, if there are duplicate notices about the same set, only the first notice received may be shown. In some cases, if a user has a notice directly from a set author (i.e. a sending notice), only the notice from the set author may be shown. In some cases, notices for a set may not be shown if the recipient has already accepted and/or subscribed to the set, which are described in further detail below. In some cases, when one or more notices have been suppressed, the recipients may be notified that the notices have been suppressed. In some embodiments, notice messages associated with notices that are not shown may be preserved and provided to the recipient in some form.

In some embodiments, the recipient of a message or set may be able to forward that message or set to one or more other recipients. A recipient who has received a sending notice directly from an author may be referred to as a “first degree” recipient. A recipient who has received a forwarding notice from a first degree recipient may be referred to as a “second degree” recipient. Similarly, a recipient who has received a forwarding notice from a second degree recipient may be referred to as a “third degree” recipient, and so on.

In some embodiments, permission to forward a message or set may be limited to recipients of a preselected degree (e.g. degree “n”). For example, if forwarding is limited to second degree recipients (i.e. n=2), then individuals who receive the notice from the second degree recipients (i.e. the 3^{rd} degree recipients) may be restricted from forwarding that set. In some cases, there may not be any limit on the forwardability of the set (e.g. n=null or n=−∞). That is, an unlimited amount of forwarding is allowed. In some cases, there may be no forwarding permitted (e.g. n=0). The forwardability of a message or set may be configurable by its author when the message or set is generated. In some embodiments the forwardability of a message or set may be configurable by its author after the message or set is generated.

In some embodiments, users who have permission to forward a message or set may be limited to recipients that have accepted the message or set. Acceptance of the message or set is explained in further detail herein below.

When a recipient receives a notice for a set or message, the user may interact with the notice to view the set or message. For example, if a link to the set is provided in the notice, the recipient may interact with the notice by clicking on the link. In some embodiments, if a recipient is a user who is not logged in to the system, the recipient may be prompted to log in to the system to access the set or message. In some embodiments, if a recipient is not a user of the system, the recipient may be prompted to register as a user to access the set or message.

In some embodiments, if a recipient of a notice has interacted with the notice to access a message or set, the fact that the recipient has accessed the message or set may be noted. This information may, for example, be used to provide an author with information about which recipients have accessed the set.

Communicating a notice relating to a message or set may automatically provide at least temporary access to the message or set. In some embodiments, access to the message or set may become limited to the author and some number of recipients who have selected to accept the set. For example, a recipient of a notice may be granted access to the message or set only for a predetermined amount of time. In some cases, a recipient of a notice may be granted access to a set so long as the set remains open. In these cases, when a set becomes closed, access previously granted to recipients who have not accepted the set may be revoked. In some cases, a recipient of a notice may be granted access to the set for a predetermined number of times or instances. That is, the recipient of the notice may be allowed to access the set for a limited number of times. In some cases, when the maximum number of access times is reached or is almost reached, the server 12 may indicate to the user that he/she has reached or is about to reach the maximum amount of access permitted and encourage the user to accept and/or subscribe to the set to continue to have access to the set.

In some embodiments, recipients who have received a notice relating to a message or set, and/or who are able to view a notice relating to a message or set that has been published, may be provided with an option to “accept” the message or set. Acceptance may function as a form of communication by the user accepting the message or set. For example, accepting a set may indicate that the user likes the set, supports the set, wishes to retain access to the set, and/or agrees to pray regarding the set. This acceptance functionality may be described in many ways, and the description may correspond to the type of communication facilitated. For example, terms such as “like”, “support”, “agree”, “I will”, or “save” might be used.

In some embodiments, recipients who have received a notice relating to a message or set, and/or who are able to view a notice relating to a message or set that has been published, may be provided with an option to “decline” the message or set. Declining may function as a form of communication by the user declining the message or set. For example, declining a set may indicate that the user dislikes the set, does not support the set, is not interested in retaining access to the set, does not wish to see the set again in the future, and/or does not agree to pray regarding the set. This declining functionality may be described in many ways, and the description may correspond to the type of communication facilitated. For example, terms such as “dislike”, “disagree”, “no thank you”, “delete” or “hide” might be used.

In some embodiments, those who accept a message or set may receive automatic notifications whenever the message or set is updated. For example, users who have accepted a message may be notified when the message is modified. As another example, users who have accepted a set may be notified when a new message has been added to the set and/or an existing message in the set has been modified.

In some embodiments, in addition to or instead of the option to accept a message or set, recipients who have received a notice relating to a message or set, and/or who are able to view a notice relating to a message or set that has been published, may be provided with an option to subscribe to the message or set. Subscription and acceptance may be different such that a user is able to accept a message or set without subscribing to the message or set. In some cases a user may be able to subscribe to a set without accepting the set. The user may also be able to accept and subscribe to the set. In some cases subscription to a message or set may only be allowed for those who have accepted the message or set.

A subscription to a message or set may indicate that a user wishes to continue to be informed about updates to the message or set. For example, someone who receives a prayer request may wish to pray for the request on an ongoing basis (and thus may wish to accept and subscribe), or may wish to pray for the request once and then not receive further notifications (and thus may wish to accept but not subscribe). In some cases, users who subscribe to a message or set may also be provided with continuing access to the message or set.

In some embodiments, when a subscriber/acceptor has been provided with an update to a message or set, the subscriber/acceptor may communicate an acknowledgement to indicate that he/she has read the update. In some embodiments, the communication by the subscriber/acceptor may be inferred from the subscriber/acceptor's activity. For example, if the subscriber/acceptor accesses the message or set that has been updated, the system may infer that the subscriber/acceptor has reviewed the update.

In some embodiments, users who have accepted and/or subscribed to a message or set may be provided with one or more feedback mechanisms associated with the set for communicating with the author of the set. For example, the feedback mechanism may include a control, such as a clickable button, which can be activated by the user to communicate to the author.

A feedback mechanism may be used to communicate a wide variety of messages. For example, activating the control may communicate a request for the set author to add to or update the set. In another example, activating the control may indicate whether the user activating the control likes or dislikes a message in the set, or the set itself. Activating the control may also indicate a request for the author to contact the user activating the control.

In some embodiments, the feedback mechanism may be disabled after first activation to discourage “spamming” and to improve the usefulness of the feedback information. For example, the mechanism may be disabled for a pre-determined length of time, or permanently, or until a pre-determined event occurs (for example until the set is updated or added to).

In some embodiments, the system 10 may provide a number of reporting tools that may provide various types of information about a message or set. The reporting tools may allow information about a message or set to be accessed or viewed by an author of the message or set. In some cases the reporting tools may allow at least some portion of information about a message or set to be accessed or viewed by users who are not an author of the message or set.

In some cases, the information provided by the reporting tools may include information about recipients who have viewed or accessed the message or set.

In some cases, the information provided by the reporting tools may include information about users who have accepted and/or subscribed to the message or set.

In some cases, the information provided by the reporting tools may include one or more map displays configured to indicate the location of users who have accepted and/or subscribed to the message or set.

In some cases, the information provided by the reporting tools may include one or more relationship networks illustrating relationships between various users that are related to the message or set. For example, a relationship network may illustrate how each of the users that have accepted the set obtained notice of a set. In another example, a relationship network may indicate how each of the users who have accepted a set are related to one another.

In some cases, the information provided by the reporting tools may include one or more requests from one or more users for the author to update a message or set. For example, a user who has agreed to pray regarding a set may wish to receive an update about the topic that inspired the set.

In some cases, the information provided by the reporting tools may include information about whether users have accessed the most recent update to the message or set.

In some cases, the information provided by the reporting tools may include statistical data on the acceptors and/or subscribers of the set, where such data may be drawn from profile data made available to the author by acceptors and/or subscribers.

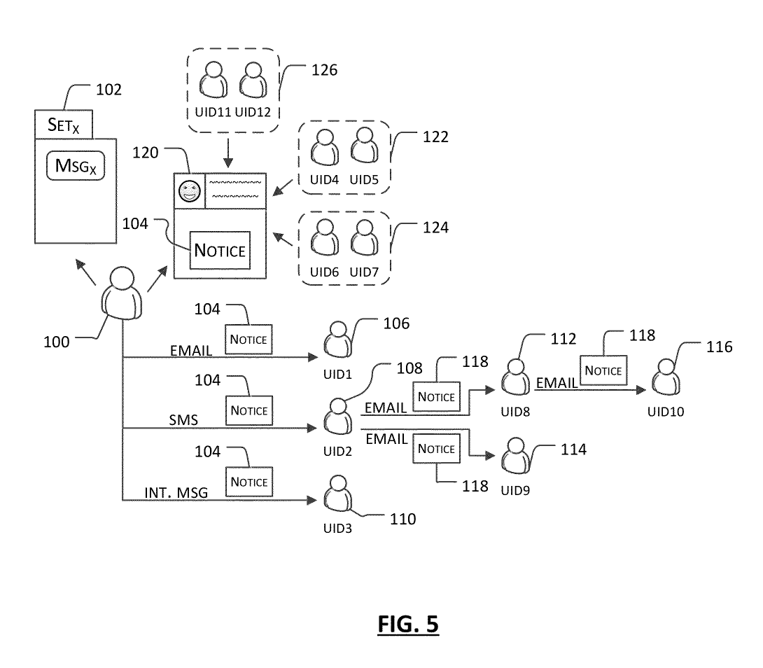

Exemplary operation of how various users may communicate with each other using the system 10 according to some embodiments will now be described with reference to FIG. 5. Referring now to FIG. 5, illustrated therein is an author 100 who authored (i.e. generated) the set Set including message Msgₓ indicated by reference numeral 102. Setₓ, for example, may be a prayer request for a particular topic. That is, the content of Set (and Msgₓ) may provide a topic that the author wishes prayer for.

After generating the set 102, one or more first notices indicated by reference numeral 104 may be generated. A notice 104 may include an option to access to the set 102. For example, a notice 104 may include a URL indicative of a location of the set 102. In some cases, the one or more notices 104 may not be generated automatically and/or immediately after a set is created. For example, the author 100 may generate the set 102 and then wait for a period of time before generating the one or more notices 104 associated with the set 102. In some cases, the author 100 may not generate any notices. In some cases, the author 100 may generate multiple sets of one or more notices, where each set of one or more generated notices may be generated at a different time.

Notices 104 may be sent to a number of recipients using different means and/or different formats. For example, in FIG. 5 a notice 104 is sent to a user associated with user identifier UID1, indicated by reference numeral 106, via electronic mail (i.e. email). Another notice 104 is sent to a user associated with user identifier UID2, indicated by reference numeral 108, via text messaging (e.g. SMS). Another notice 104 is sent to a user associated with user identifier UID3, indicated by reference numeral 110, using an internal messaging feature of system 10. In some cases multiple notices 104 may be sent to the same user, and those multiple notices may be sent to that same user using different means and/or different formats. It should be understood that while the author 100 in the present example is shown to use different means to communicate the notice 104, he need not do so. In other examples, the author may wish to communicate the notice using just one way (e.g. internal messaging) or desired combination of communication means (e.g. internal messaging+emails).

In some cases, one or more notices 104 may be sent to individuals who are not registered users. For example, notices 104 may be sent by email to one or more recipients who may not have a user account in the social network. In such cases, a new user account associated with the recipient may be created. For example, if a notice is sent to an email address associated with an individual who is not a registered user of the system, a notice may also be sent using an internal messaging system to an account associated with that individual. If necessary a new account associated with that email recipient may be generated automatically. Such a user account may be designated as an “email-only user account”. If the recipient (the individual who receives the notice via email) later decides to register as a user in the social network, then any notices associated with their email-only user account may be transferred to his or her regular user account .

In some cases, when a notice 104 is sent to a recipient using the internal messaging system, the internal messaging system may also deliver one or more notices 104 to that recipient via other delivery means based upon notification preferences provided by the recipient. For example, a user may have configured the notification preferences such that when a notice is received via the internal messaging system, an additional notice is sent to the user by email. In the case of a recipient that is not a registered user, an additional notice may be sent by email as a default. This version of the notice may include at least some portion of the content of Setx (and Msgx), and may include links allowing recipients to easily communicate with the system, for example to accept and subscribe, to accept but not subscribe, or to decline the request. This version of the notice may also include a link to allow the user to quickly log into the system to view the request (and to first register as a user if necessary). This version of the notice may also include a link to accept and forward (which may also subscribe the recipient), which will allow the user to quickly log into the system to generate one or more new forwarding notices 118 for the request there (which may function in ways similar to a notice sent by the author).

Referring again to the example shown in FIG. 5, the user 108 has sent forwarding notices 118, via email, to user 112 with user identifier UID8 and user 114 with user identifier UID9. In turn, the user 112 has sent a forwarding notice 118, via email, to user 116 with user identifier UID10. The users 106, 108 and 110 are classified as direct recipients or first degree recipients of set 102 as they obtained notice directly from the author 102. The users 112 and 114 are classified as second degree recipients of set 102 as they obtained notice from a direct recipient. The user 116 is classified as a third degree recipient since he or she obtained notice from a second degree recipient. In these cases, the forwarding activity by user 108 and user 112 may be facilitated using a forwarding tool in the system. For example, the user 108 may enter a recipient email's address (i.e. email of user 112) in the forwarding tool and the forwarding tool may facilitate sending a second notice, that is, a forwarding notice 118 to the user 112. While using a forwarding tool may require additional steps in comparison to the forwarding options provided by the user 108′s email client, use of the forwarding tool may facilitate monitoring and control features described herein. In some cases, only users who receive notices or forwarding notices generated on the system 10 may be granted access to the set.

When first notices 104 and forwarding notices 118 are communicated to users 106, 108, 110, 112 and 114 the system 10 may automatically grant these users permission to forward the set 102. However, if the author has limited forwarding to a degree of 2, the user 116 will not be automatically granted permission to forward the set 102.

In addition to sending notices 104 to targeted recipients, the author 102 has also published (i.e. posted) a notice 104 on a social networking profile 120. In this example, the author 102 set up his or her privacy settings such that users who are in “Friends” group 122 and/or “Church” group 124 are able to view the notice on the social networking profile 120. The author 102 has also set up his or her privacy settings such that users who are in “Work” group 126 are prevented from viewing the notice on the social networking profile 120.

When the notice 104 is posted to the social networking profile 120, the system 10 may automatically grant access to the set 102 for any individual or entity who has access to the profile 120. Alternately the system 10 may detect the user identifiers who have been granted permission to access the set 102 and automatically grant them access to the set 102. In some cases, the access granted may be temporary. In the present example, users with user identifiers UID4 and UID5 in the Friends group 122 are automatically granted access to the set 102. Similarly, users with user identifiers UID6 and UID7 in the Church group 124 are automatically granted access to the set 102. In contrast, users UID11 and UID12 in the Work group 126 are not granted access to the set 102 since these users are not permitted to view the posting of the notice in the author's social networking profile 120.

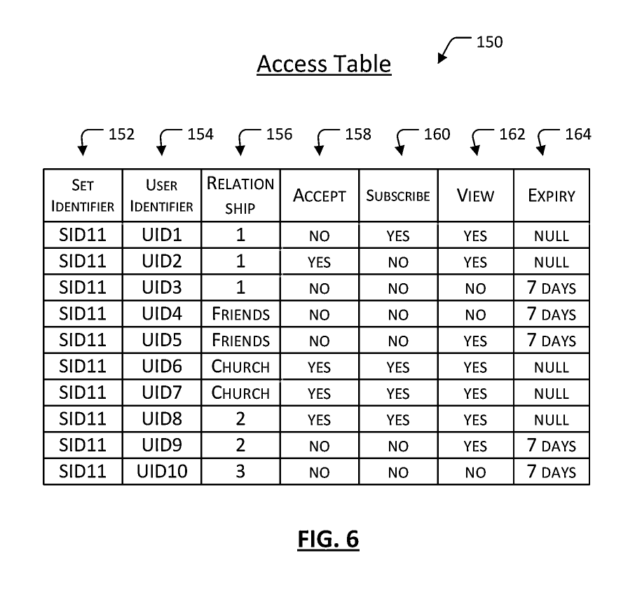

The system 10 may keep track of user access to the set 102 using different means. Referring now to FIG. 6, illustrated therein is an exemplary USER_SET_ACCESS table 150 for tracking user access to one or more sets according to some embodiments. The table 150 may be a junction table between a USER table (not shown) and the set table (e.g. Table 50). The table 150 tracks relationships between various user identifiers and various sets.

The table 150 includes a plurality or columns and rows. Each row represents a user identifier and a set that it has access to. The row also include additional information such as how the user identifier obtained access, whether the user identifier has “accepted” the set, whether the user identifier has subscribed to the set, whether the user identifier has viewed the set, and when the access for the user identifier expires, if it expires. This information is stored in various columns of the table 150.

The table 150 includes a Set column 152, which stores information indicative of various sets the user identifier in each row has access to. In the example as shown, all of the users in the table have access to set 102, which has a Set Identifier value “SID11”.

The table 150 includes a User column 154, which stores information about the user identifier that has access to various sets. In the example as shown, users with user identifiers UID1-UD10 are recorded as these users have access to the set indicated in column 152 (i.e. Setₓ) in each respective row. The users UID11 and UID12, however, do not have access to the set 102 because they don't have access to the notice 104 posted on the social networking profile 120. As these users do not have access to the set 102, information about these users is not recorded in the table 150.

The table 150 includes a Relationship column 156, which stores information indicative of how the user in each of the rows obtained access to the set 102. In the example as shown, users with user identifiers UID1, UID2 and UID3 obtained access because they are direct recipients (i.e. first degree recipients) of the notice, users with user identifiers UID8 and UID9 obtained access because they have received a forward from a direct recipient (i.e. they are second degree recipients), and the user with user identifier UID10 obtained access because they are a third degree recipient. The user identifiers UID4, UID5, UID6 and UID7 obtained access by virtue of having access to the posting of a notice 104 to the social networking profile 120. In some cases, user identifiers UID4, UID5, UID6 and UID7 may be indicated as direct recipients. In some cases a Relationship column 156 may store information regarding which social networking profiles users may have obtained access to the set 102 through.

The table 150 includes an Acceptance column 158, which stores information indicative of which of the users have “accepted” the set 102. In the example as shown, all of the users with user identifiers UID2, UID6, UID7 and UID8 have accepted the set 102, which in this case could mean that they have agreed to pray on the topic presented by the author in the set 102.

The table 150 includes a Subscription column 160, which stores information indicative of which of the users have subscribed to the set 102. In the example as shown, the users with user identifiers UID1, UID6, UID7 and UID8 have subscribed to the set, which in this case could mean that these users will receive a notification each time the set 102 is updated.

The table 150 includes a Viewed column 162, which stores information indicative of which of the users have viewed the set 102. In the example as shown, the users with user identifiers UID3 and UID4 have not viewed the set 102, and the users with other listed user identifiers have accessed the set 102 at least one time. In some cases the Viewed column 162 may store information indicative of how many times users have viewed the set 102.

The table 150 also includes an Access Expiry column 164. The information stored in column 164 indicates when the access granted to the user will expire. In the present example, access for the user identifiers who have subscribed to and/or have accepted the set will never expire. However, access to the rest of the users will expired in the stated number of days. For example, temporary access granted to the users with user identifiers UID3, UID4, UID5, UID9 and UID10 will expire in seven days.

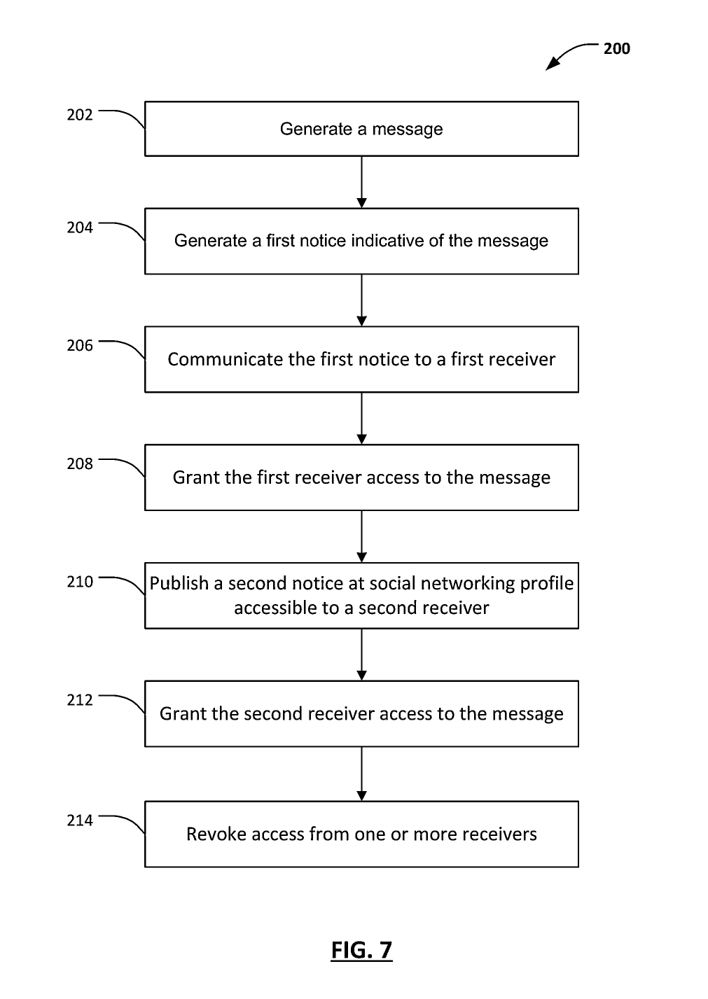

Referring now to FIG. 7, illustrated therein is a method 200 for electronic messaging according to some embodiments. The method 200 may be executed by one or more processors in the system 10 described herein above.

The method starts at step 202 wherein at least one message is generated. In some cases, the message may be contained in a set.

At step 204, at least one first notice indicative of the at least one message is generated.

At step 206, the at least one first notice is communicated to at least one first receiver having an associated first user identifier.

At step 208, the first receiver having an associated first user identifier is automatically granted access to the at least one message.

At step 210, at least one second notice is published at a social networking profile associated with at least one user. The at least one second notice is accessible to at least one second receiver having an associated second user identifier.

At step 212, the at least one second receiver having an associated second user identifier is automatically granted access to the at least one message.

At step 214, access associated with one or more user identifiers is revoked. For example, receivers having associated user identifiers who were granted access automatically may have their access revoked after a period of time.

It should be understood that the method 200 described herein above is only for exemplary purposes. In various embodiments, one or more of the steps of the method may be omitted, performed in different order, and/or one or more other steps may be included in the method.

It should be understood that even though the embodiments of the messaging system are described herein in relation to a faith-based social networking system, they may be applicable in other fields of technology, such as other social network applications or other means for electronic communication.

While the above description provides examples of one or more apparatus, methods, or systems, it will be appreciated that other apparatus, methods, or systems may be within the scope of the present description as interpreted by one of skill in the art. Moreover, the scope of the claims appended hereto should not be limited by the embodiments set forth in the examples, but should be given the broadest interpretation consistent with the description as a whole.

1. A communication system comprising
(a) a plurality of electronic devices;
(b) a server in data communication with the plurality of electronic devices, the server having at least one processor, the processor being configured to:
(i) generate at least one message, the at least one message being accessible only by authorized receivers having associated user identifiers;
(ii) generate at least one notice indicative of the at least one message;
(iii) communicate the at least one notice to at least one first receiver having an associated first user identifier; and
(iv) automatically grant the at least one first receiver access to the at least one message.

2. The communication system of claim 1, wherein the processor is configured to grant the at least one first receiver access to the at least one message by granting access to the first user identifier.

3. The communication system of claim 1, wherein the processor is configured to publish the at least one notice at a location, the published notice being accessible to the at least one first receiver.

4. The communication system of claim 3, wherein the at least one notice is published at a location comprising a social networking profile associated with at least one user.

5. The communication system of claim 3, wherein the processor is configured to automatically grant the at least one first receiver access to the at least one message.

6. The communication system of claim 5, wherein the processor is configured to automatically grant the at least one first receiver access to the at least one message based upon the security settings associated with the location.

7. The communication system of claim 1, wherein the processor is configured to send the at least one notice to an electronic communication address associated with the at least one first receiver.

8. The communication system of claim 7, wherein the processor is configured to automatically grant the at least one first receiver access to the at least one message by granting access to the electronic communication address associated with the at least one first receiver.

9. The communication system of claim 1, wherein the processor is configured to:
(a) generate at least one forwarding notice upon request by the at least one receiver; and
(b) communicate the at least one forwarding notice to at least one second receiver having an associated second user identifier.

10. The communication system of claim 9, wherein the processor is configured to automatically grant the at least one second receiver access to the at least one message.

11. The communication system of claim 9, wherein the processor is configured to grant the at least one second receiver access to the at least one message by granting access to the second user identifier.

12. The communication system of claim 1, wherein the processor is configured to:
(a) generate at least one receiver published notice upon request by the at least one receiver;
(b) communicate the at least one receiver published notice to at least one third receiver by publishing the at least one receiver published notice at a location, the published receiver published notice being accessible to the at least one third receiver.

13. The communication system of claim 12, wherein the at least one receiver published notice is published at a location comprising a social networking profile associated with at least one user.

14. The communication system of claim 12, wherein the processor is configured to automatically grant the at least one third receiver access to the at least one message.

15. The communication system of claim 1, wherein the processor is further configured to determine whether to allow at least one forwarding notice or receiver published notice to be communicated based upon a distribution limitation setting.

16. The communication system of claim 15, wherein a number of selectable distribution limitation setting configurations is greater than two.

17. The communication system of claim 15, wherein the distribution limitation setting prevents receivers from communicating a forwarding notice.

18. The communication system of claim 15, wherein the distribution limitation setting prevents a specified receiver from communicating a forwarding notice.

19. The communication system of claim 15, wherein the distribution limitation setting permits receivers to communicate a forwarding notice.

20. The communication system of claim 15, wherein the distribution limitation setting permits a specified receiver to communicate a forwarding notice.

21. The communication system of claim 15, wherein the distribution limitation setting permits first degree receivers to communicate a forwarding notice.

22. The communication system of claim 15, wherein the distribution limitation setting prevents receivers from communicating a forwarding notice based upon a selected degree of recipient.

23. The communication system of claim 15, wherein the distribution limitation setting permits receivers to communicate a forwarding notice based upon a selected degree of recipient.

24. The communication system of claim 15, wherein the distribution limitation setting prevents receivers from communicating a receiver published notice.

25. The communication system of claim 15, wherein the distribution limitation setting permits receivers to communicate a receiver published notice.

26. The communication system of claim 15, wherein the distribution limitation setting permits receivers to communicate receiver published notices if a distribution limitation setting permits all receivers to communicate a forwarding notice.

27. The communication system of claim 15, wherein the distribution limitation setting allows only receivers who have accepted the at least one message to communicate a forwarding notice or receiver published notice.

28. The communication system of claim 15, wherein the distribution limitation setting allows only receivers who have subscribed to the at least one message to communicate a forwarding notice or receiver published notice.

29. The communication system of claim 1, wherein the processor is further configured to automatically revoke a permission previously granted to a receiver.

30. The communication system of claim 29, wherein revoking a previously granted permission comprises one or more of:
(a) revoking ability of one of the receivers to access the at least one message;
(b) revoking ability of one of the receivers to communicate a forwarding notice; and
(c) revoking ability of one of the receivers to communicate a receiver published notice.

31. The communication system of claim 29, wherein a previously granted permission is revoked after an expiry of a period of time.

32. The communication system of claim 29, wherein a previously granted permission is revoked based upon a distribution limitation setting.

33. The communication system of claim 29, wherein a previously granted permission is revoked based upon whether the at least one message is open or closed.

34. The communication system of claim 29, wherein a previously granted permission is revoked based upon whether one of the receivers has unsubscribed or unaccepted the at least one message.

35. The communication system of claim 1, wherein the processor is further configured to store information indicative of whether the at least one receiver has viewed the at least one message.

36. The communication system of claim 1, wherein the processor is further configured to store information indicative of whether the at least one receiver has accepted the at least one message.

37. The communication system of claim 1, wherein the processor is further configured to store information indicative of whether the at least one receiver has subscribed to the at least one message.

38. The communication system of claim 1, wherein the processor is further configured to store information indicative of how the at least one receiver obtained access to the at least one message.

39. The communication system of claim 1, wherein the processor is further configured to store access information of one or more types in an access table.

40. The communication system of claim 1, wherein the processor is further configured to send an update notification to the at least one receiver based upon how the at least one receiver interacted with the at least one message.

41. The communication system of claim 40, wherein the at least one receiver's interaction with the at least one message comprises accepting the at least one message.

42. The communication system of claim 40, wherein the at least one receiver's interaction with the at least one message comprises subscribing to the at least one message.

43. The communication system of claim 1, wherein the at least one message is indicative of at least one prayer request.

44. A computer implemented communication method comprising:
(a) generating at least one message, the at least one message being accessible only by authorized receivers having associated user identifiers;
(b) generating at least one notice indicative of the at least one message;
(c) communicating the at least one notice to at least one first receiver having an associated first user identifier; and
(d) automatically granting the at least one first receiver access to the at least one message.

45. A communication device comprising at least one processor, the processor being configured to:
(a) generate at least one message, the at least one message being accessible only by authorized receivers having associated user identifiers;
(b) generate at least one notice indicative of the at least one message;
(c) communicate the at least one notice to at least one first receiver having an associated first user identifier; and
(d) automatically grant the at least one first receiver access to the at least one message.
